(19) United States
(12) Patent Application Publication
(10) Pub. No.: US 2002/0071805 A1
(43) Pub. Date: Jun. 13, 2002

(54) Method and means of preparing chlorinated bicarbonates and carbonates of calcium and alkali metals

(76) Inventors: Mohammed N. I. Khan, Clear Lake, IA (US); M. Fazlul Hoq, Worthington, OH (US)

Correspondence Address: ZARLEY, McKEE, THOMTE, VOORHEES & SEASE, Suite 3200, 801 Grand Avenue, Des Moines, IA, 50309, US

(21) Appl. No.: 09/733,488

(22) Filed: Dec. 8, 2000

Related U.S. Application Data
(60) Provisional application No. 60/170,770, filed on Dec. 15, 1999.

(51) Int. Cl. C01B 11/12

(52) U.S. Cl. 423/475

(57) ABSTRACT

A novel method of producing chlorate is described which involves the chlorination of bicarbonates and carbonates of calcium and/or alkali metals. The bicarbonates and carbonates used in the reaction are preferably the waste by-products of ammonium chlorate plants, while the chlorine is preferably the waste by-product of chlor-alkali plants. The method saves 15% or more of the electrical energy involved in the electrochemical reaction for the preparation of chlorate.

### CROSS-REFERENCE TO RELATED APPLICATION

This application claims priority to provisional application Ser. No. 60/170,770 filed Dec. 15, 1999.

### FIELD OF THE INVENTION

This invention relates to the preparation of a chlorinated solution of bicarbonates and carbonates of calcium and/or alkali metals as a replacement feed for sodium chloride feed in chlorate plants.

### BACKGROUND OF THE INVENTION

The manufacture of ammonium chlorate using sodium chlorate (see e.g. U.S. Pat. No. 5,948,380) produces sodium bicarbonate as a waste by- product. Similarly, preparation of ammonium chlorate using calcium chlorate produces calcium carbonate as a waste by-product.

Ammonium chlorate manufacturers are always looking for profitable and environmentally safe uses for these sodium bicarbonate and calcium carbonate waste by-products.

The most inexpensive source of sodium hydroxide is from chlor-alkali plants. Conventional feed material for chlor-alkali cells is sodium chloride solution. Along with sodium hydroxide, the chlor-alkali process produces chlorine as an inevitable by-product. Until recently, chlorine was used as a bleaching agent in the production of white pulp and paper, and in water purification.

Also, chlorine has uses in the manufacture of feed chemicals in the production of polymers, such as polyvinyl chloride. Extensive research has been done on the chemical and physical properties and uses of chlorine since its discovery over one hundred years ago. An excellent compilation of most of the important works done by different laboratories and chemical manufacturers has been recorded in the book, “CHLORINE, Its Manufacture, Properties and Uses” by Editor-in-chief J. S. Conc, Reinhold Publishing Corporation, New York (1962). This book will herein be referenced as “CHLORINE”. The Environmental Protection Agency (EPA) has now prohibited the use of chlorine for pulp bleaching since it has been found to produce highly hazardous organochlorine compounds. Sodium hydroxide producers have therefore been searching for alternative uses of hazardous chlorine by-product.

Chlorine dioxide has replaced chlorine as the primary bleaching agent in the production of white pulp and paper. Chlorine dioxide is also used for water purification. It is now the most important worldwide commodity for these purposes.

Existing technologies for commercial production of chlorine dioxide involves the reduction of sodium chlorate/chloric acid with reducing agents such as hydrogen peroxide and glycerol, glycol (See e.g. U.S. Pat. Nos. 5,093,097; 5,091,166; 5,380,517; 5,486,344; and 5,487,881), methanol (U.S. Pat. Nos. 4,978,517 and 5,174,868) and chloride (U.S. Pat. No. 5,458,858). The typical means of obtaining sodium chlorate as a feed chemical in the production of chlorine dioxide is through electrochemical reaction of aqueous sodium chloride (brine solution) in the chlorate cell. This preliminary step of processing the brine solution is not very efficient, however, since it expends large quantities of electricity.

There is therefore a need in the art for an improved means of using chlorine waste by-product from chlor-alkali plants.

There is also a need in the art for an improved means of using sodium bicarbonate and calcium carbonate waste by-product from ammonium chlorate plants.

There is also a need in the art for a means of minimizing the overall costs of producing chlorate feed chemical for use in the production of chlorine dioxide.

It is therefore a primary objective of the present invention to provide a novel means of using chlorine waste by-product from chlor-alkali plants and sodium bicarbonate and calcium carbonate waste by-product from ammonium chlorate plants.

It is a further objective of the present invention to provide a method and means of using chlorine waste by-product from chlor-alkali plants and sodium bicarbonate and calcium carbonate waste by-product from ammonium chlorate plants that is environmentally safe.

It is still a further objective of the present invention to provide a means of producing chlorate feed material that is more efficient and requires less electricity than conventional means.

It is yet a further objective of the present invention to provide a means of producing chlorate that decreases overall production costs.

These and other objectives will become apparent from the following description.

### SUMMARY OF THE INVENTION

The present invention describes a method and means of producing feed chemical for chlorate plants that consists of a chlorinated solution of bicarbonates and carbonates of calcium and/or alkali metals. Preferably, the invention involves the reaction of chlorine as a waste by-product of chlor-alkali plants, with calcium carbonate and/or sodium bicarbonate as waste by- products of ammonium chlorate plants.

The reaction involves the chlorination of bicarbonates or carbonates of calcium and/or alkali metals to form 16.66% chlorate. In comparison to conventional methods of manufacturing chlorine dioxide, use of chlorate from this invention saves at least 15% in electrical energy due to elimination of the preliminary step of electrochemical oxidation of sodium chloride to sodium chlorate.

### DETAILED DESCRIPTION OF THE PREFERRED EMBODIMENT

As set forth above, the present invention discloses a novel method of producing chlorate using the waste by-products of chlor-alkali and ammonium chlorate plants. Specifically, the invention relates to the chlorination of bicarbonates or carbonates of calcium and/or alkali metals to form a mixture of one chlorate and five chloride, which may be used as feed for the production of chlorate.

Inorganic and physical chemists recognize that aqueous solutions of alkali and alkali earth metal carbonates and bicarbonates undergo reversible hydrolysis to produce alkalis. For example, the strong alkaline nature of sodium carbonate solution (e.g. a half molar solution has pH >12) has been attributed to the following equilibrium reaction:

Na₂CO₃+H₂O [symbol] 2NaOH+H₂CO₃ (1)

It has also been recognized that alkalis provide hydroxide ions in aqueous solution. Chlorine reacts with hydroxide ion to generate hypochlorite or chlorate or both depending upon the temperature and concentration of the hydroxide solutions (See e.g. CHLORINE, p. 40):

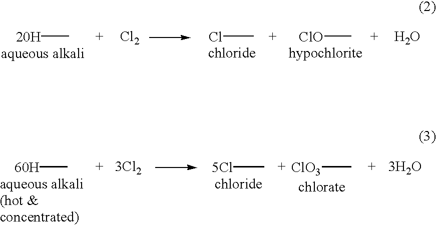

Reactions 1, 2, and 3 demonstrate that chlorination of concentrated aqueous solution or suspension of bicarbonates and carbonates of calcium and/or alkali metals oxidizes one chlorine atom (out of six chlorine atoms) into chlorate, while the other five chlorine atoms are reduced to chloride.

As compared to conventional sodium chloride feed for the production of sodium chlorate by electrochemical processes, the present invention involves direct feeding of chlorinated bicarbonate and carbonate which saves 16.66% (=⅙×100) of electrical energy involved in electrochemical reaction in the chlorate cell.

Calcium chlorate made in accordance with this invention may also be used in the manufacture of ammonium chlorate by absorbing stoichiometric amounts of ammonia and carbon dioxide gas in a 0.5 M to saturated aqueous solution of calcium chlorate at a temperature of between 0-100° C., as shown in the following reaction:

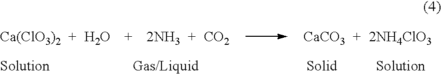

In the alternative, solid, aqueous suspension, 0.5 molar to saturated aqueous solution or vapors of ammonium carbonate or ammonium bicarbonate can be mixed with a 0.5 molar to saturated aqueous solution of calcium chlorate at 0-100° C. as shown by the following reactions:

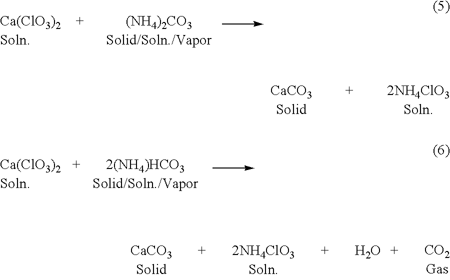

Any calcium or alkali metal carbonate or bicarbonate is suitable for use in this invention. However, the preferred source of carbonate/bicarbonate is the waste by-products from ammonium chlorate plants, which consist of the carbonates/bicarbonates of sodium and calcium. Similarly, the preferred source of chlorine for use in this invention is the waste by-product of chlor- alkali plants.

Calcium is the only metal outside of the alkali metal family that will not interfere with the functioning of a chlorate cell, and therefore may also be used in this invention. Calcium's diagonal relationship with respect to sodium in the periodic table of elements makes it behave in a fashion comparable to sodium in a chlorate cell. For example, calcium ion and sodium ion are comparable in terms of the following properties: (i) electrochemical reduction to metal, (ii) solubility of their chloride, hypochlorite, chlorate and chromate salts, and (iii) reaction of chlorine with their hydroxides. Calcium chloride may therefore be converted to calcium chlorate using the same electrochemical cells that are used in the conversion of sodium chloride to sodium chlorate.

The reaction of this invention involves bubbling chlorine through a 6-60% by weight slurry of at least one bicarbonate or carbonate in water. This causes the following one or more of the following reactions to take place:

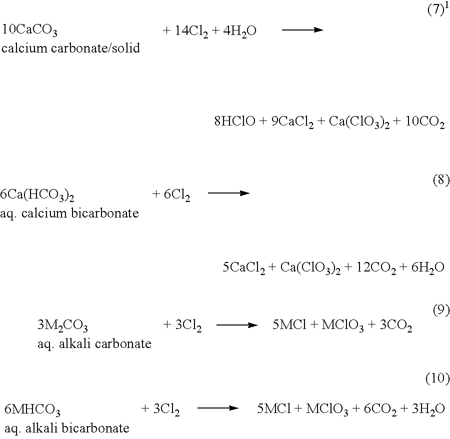

Wherein M =an alkali metal (column I element of the periodic table).

Preferred alkali metals for use in this invention are sodium and potassium. Instead of feeding suspension of carbonate/bicarbonate, water and solid carbonate/bicarbonate may be fed directly into the reactor (as described in Example 1). The carbonate/bicarbonate may also be added into a reactor containing an aqueous 0.01 M to saturated solution of chlorine, as described in Example 2.

For maximum contact of bubbling chlorine with bicarbonate/carbonate, the slurry is preferably kept in a tall container, such as a batch or flow reactor, and is subjected to a swirling motion, while chlorine is released in fine bubbles using a gas spurger at the bottom of the container. The reactor may be a tall vessel of any size and shape, preferably cylindrical, and may be made of any material that is inert to the corrosive actions of chlorine. For example, the diameter of the reactor may range from 3-3000 cm, and its height may range from 300 to 3×10⁶ cm. The reaction mixture is preferably stirred with a rotating coaxial hollow cylindrical shaft with multiple blades at orientations to provide maximum circular motion of chlorine bubbles perpendicular to the axis. The shaft should be made of material having good thermal conductivity and inertness to the corrosive action of chlorine.

The temperature range of the reaction is not critical, and may range from 0-100° C. The preferred reaction temperature is 20-60° C. The temperature of the reactor may be maintained by placing a cooling or heating system inside the hollow shaft in the reactor. Heating occurs by placing a heating rod coaxially inside the shaft, and cooling occurs by keeping the shaft filled with flowing water.

The chlorination reaction is completed when the pH value of the reaction mixture is lowered to an acidic range of between about 1-4, indicating that carbonates and bicarbonates have been completely converted to an aqueous solution of chloride, hypochlorite, and chlorate. After the completion of chlorination, if necessary, the reaction mixture may be concentrated or diluted and its acidity adjusted in the presence of chromate buffer to reach the concentration and pH of typical chlorate cell electrolyte. For calcium chlorate preparation, it may be necessary to increase the acidity of the electrolyte solution by about 0.2 to 2.2 pH units in order to avoid precipitation of calcium carbonate during the reaction.

During the reaction, unreacted chlorine gas in carbon dioxide gas is preferably removed. The most efficient means of accomplishing this is to allow the carbon dioxide gas to rise in a commercial gas absorption tower while saturated solution of carbonate/bicarbonate moves downwardly through the packing of the column when reactions 8, 9, and 10 occur. Chlorine-free carbon dioxide gas may be converted to dry ice, or may be added to an aqueous ammonia solution to make ammonium bicarbonate according to the following reaction 11a, or may be added to an aqueous suspension of calcium carbonate to form aqueous solution of calcium bicarbonate according to reaction 11b:

H₂O+CO₂+NH₃→NH₄HCO₃ (11a)

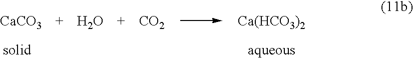

Generated carbon dioxide gas is most preferably purified from its chlorine impurities before releasing into the atmosphere or using for ammonium chlorate preparation by scrubbing with saturated solutions of calcium or sodium bicarbonate using commercial gas absorption towers.

The following examples are offered to illustrate but not limit the invention. Thus, they are presented with the understanding that various formulation modifications as well as reactor modifications may be made and still be within the spirit of the invention.

### EXAMPLE 1

### Reactor for Counter-Current Chlorination of a Descending Slurry of Carbonates and Bicarbonates Inside a Cylindrical Tower

Carbonates and bicarbonates are chlorinated in a tall, cylindrical reactor made of materials inert to the corrosive actions of chlorine. The height and diameter of the reactor may be of any dimension to optimize the production. The stirring system of the reactor is a rotating coaxial hollow cylindrical shaft with multiple blades at orientations to provide maximum circular motion of chlorine bubbles perpendicular to the axis. The reactor may be heated by placing a heating rod coaxially inside the shaft, and cooled by keeping the shaft filled with flowing water.

Chlorine gas is fed into the reactor through a gas sparger placed at the bottom of the reactor. The sparger is designed to provide fine bubbles of chlorine gas. Saturated solution or suspension (up to 50% by weight) of bicarbonates and carbonates of calcium and alkali metals are fed at the top of the reactor. Carbon dioxide gas exits through an outlet placed above the inlet for carbonate feed. Chlorinated solution containing chloride, hypochlorite, and chlorate exit the reactor through an outlet placed below the inlet for chlorine gas. A pH probe is placed near this outlet to monitor completion (pH 1-4) of the chlorination reaction.

Removal of the product solution and feeding rate of (i) chlorine, (ii) bicarbonate solution from chlorine scrubber tower and (iii) carbonate/bicarbonate solid are adjusted so as to keep the reaction vessel is nearly filled with reaction mixture and pH value near the outlet of product solution between 1-4.

### EXAMPLE 2

### Chlorination by Addition of Solid Carbonates and Bicarbonates into Aqueous Chlorine

Aqueous chlorine is acidic (pH 1-4) because of the following equilibrium hydrolysis generating hydrochloric acid and hypochlorous acid. (CHLORINE, p. 35).

H₂O+Cl₂ [symbol] HCl+HClO (12)

Hydrochloric acid (HCl) and hypochlorous acid (HClO) react with metal carbonates and bicarbonates to produce an aqueous solution of metal chloride, hypochlorite and chlorate and gaseous carbon dioxide. Generated carbon dioxide gas before releasing into the atmosphere or using for ammonium chlorate preparation is purified from its chlorine impurities by scrubbing with saturated solutions of calcium or sodium bicarbonate using commercial gas absorption towers.

Solid bicarbonates and carbonates of calcium and/or alkali metals are added to an aqueous 0.01 M to saturated solution of chlorine obtained by bubbling chlorine through a gas sparger placed at the bottom of a tall cylindrical tank reactor. A rotating cylindrical shaft with multiple blades is used for stirring of the reaction mixture. The orientations of the blades with the shaft is optimized to provide maximum circular motion of chlorine bubbles and particles of metal carbonates and bicarbonates. The purpose of the design is to provide maximum residence time of the chlorine bubbles in the reaction mixture. A pH probe is placed near the outlet of the product solution to monitor completion (pH=1-4) of the chlorination reaction. The tank is kept nearly filled by continuously feeding bicarbonate solution obtained from commercial gas absorption towers used for removal of chlorine impurity in product gas carbon dioxide.

The removal rate of product solution and feeding rate of (i) chlorine, (ii) bicarbonate solution from chlorine scrubber tower, and (iii) carbonate/bicarbonate solid are adjusted so as to keep the reaction vessel nearly filled with reaction mixture and pH value near the outlet of product solution at 1 to 4. The aqueous product solution of metal chloride, hypochlorite, and chlorate is obtained, and is treated to adjust the concentration and its pH to reach the concentration and pH of typical chlorate cell electrolyte feed for the sodium chlorate plant. This pH and concentration adjusted chloride-hypochlorite-chlorate solution is then fed into a normally operating sodium chlorate cell.

Having described the invention with reference to particular compositions and methods, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

What is claimed is:

1. A method of producing chlorates comprising: chlorinating one or more compounds selected from the group consisting of calcium carbonate, calcium bicarbonate, alkali metal carbonate, and alkali metal bicarbonate to form a hypochlorite/chloride/chlorate-containing reaction mixture.

2. A method according to claim 1 whereby the compound is sodium bicarbonate waste by-product from an ammonium chlorate plant.

3. A method according to claim 1 whereby the compound is calcium carbonate waste by-product from an ammonium chlorate plant.

4. A method according to claim 1 whereby the compounds are chlorinated with chlorine waste by-product from a chlor-alkali plant.

5. A method according to claim 1 further including the step of using the reaction mixture as a feed chemical for a chlorate plant.

6. A method according to claim 1 whereby the compounds are chlorinated until the reaction mixture is completely converted to an aqueous solution of chloride, hypochlorite and chlorate.

7. A method according to claim 6 whereby the pH of the converted reaction mixture is from about 1 to 4.

8. A method according to claim 1 whereby calcium chlorate is converted to ammonium chlorate by adding ammonia and carbon dioxide into a one molar to saturated solution of calcium chlorate.

9. A method according to claim 1 whereby calcium chlorate is converted to ammonium chlorate by adding ammonium carbonate or ammonium bicarbonate into a one molar to saturated solution of calcium chlorate.

10. A method according to claim 1 whereby the method comprises chlorinating a 6-60% by weight slurry of one or more of the compounds, whereby said compounds are solids.

11. A method according to claim 1 whereby the compounds are placed in a 0.001 M to saturated solution of chlorine.

12. A method according to claim 1 whereby unreacted chlorine is removed by reacting the chlorine with a 0.01 molar to saturated solution selected from the group consisting of sodium bicarbonate, calcium bicarbonate, and a mixture of sodium bicarbonate and calcium bicarbonate using chlorine scrubbers to form chlorine and spent solution.

13. A method according to claim 12 whereby the spent solution is fed as a source of water into a chlorination reactor.

14. A method according to claim 1 whereby the reaction mixture is stirred.

15. A method according to claim 1 whereby the alkali metal is potassium or sodium.

16. A method according to claim 1 whereby the compounds chlorinated are one or more of calcium carbonate or calcium bicarbonate.

17. A method according to claim 16 whereby the acidity of the mixture is increased by 0.2 to 2.2 pH units.

18. A method according to claim 17 whereby the mixture is an electrolyte mixture in a chlorate cell.

19. A method of producing chlorate comprising: chlorinating one or more compounds selected from the group consisting of calcium carbonate, calcium bicarbonate, alkali metal carbonate, and alkali metal bicarbonate to form a chlorate-containing reaction mixture; and using the reaction mixture as a feed chemical for a chlorate plant.

20. Chlorate made according to the process of claim 1.
